(19) United States
(12) Patent Application Publication
(10) Pub. No.: US 2013/0239458 A1
(43) Pub. Date: Sep. 19, 2013

(54) Counter Rotating Fishing Lure

(71) Applicants: Michael Dean Hallan, Walla Walla, WA (US); Brian Dean Burroughs, Walla Walla, WA (US)

(72) Inventors: Michael Dean Hallan, Walla Walla, WA (US); Brian Dean Burroughs, Walla Walla, WA (US)

(21) Appl. No.: 13/705,236

(22) Filed: Dec. 5, 2012

Related U.S. Application Data
(60) Provisional application No. 61/611,154, filed on Mar. 15, 2012.

(51) Int. Cl. A01K 85/12

(52) U.S. Cl. CPC A01K 85/12
USPC 43/42.2

(57) ABSTRACT

Disclosed is a counter rotating fishing lure that comprises a body section having an open center, a leading edge, a trailing edge and a pair of fins that create body rotation when fluid flows thereover. Within the open center of the body region is a freely rotating member rotatably mounted to the body region and having a pair of trailing edge fins to induce a rotation in an opposite direction of the body section. This creates a counter rotating lure as the lure is drawn through the water, while its surfaces may be adorned with various designs, textures and treatments that attract attention while in the water. The leading edge of the lure is adapted to connect to a barrel swivel and towing fishing line, while the trailing edge is adapted to connect to a fishing hook to snare a fish.

### CROSS REFERENCE TO RELATED APPLICATION

This application claims the benefit of U.S. Provisional Application No. 61/611,154 filed on Mar. 15, 2012, entitled “Fishing Flasher or Attractor.” The above identified patent application is herein incorporated by reference in its entirety to provide continuity of disclosure.

### BACKGROUND OF THE INVENTION

1. Field of the Invention

The present invention relates to artificial fishing lures and attractors. More specifically, the present invention pertains to a spinning fishing lure having a shape that produces a spinning body with a freely spinning internal element.

Artificial fishing lures are well known devices in the art for attracting fish. These devices utilized many different structures to simulate their prey. Generally these devices include a specifically designed shape, surface treatment or color, and body adornments to simulate a prey animal in the water, whereby a fishing hook is attached to the lure to snare the target fish once the lure is ingested into the mouth of the fish. Fishing lures are provided in numerous styles and shapes, and are directed to different types of fishing techniques and types of fish. Of particular emphasis in the present invention are those fishing lures are offer relative body motion with respect to the fishing line while in the water, where aerodynamic flow of the water over the lure body induces a spinning motion based on the shape and design of the lure body. Similar types of lures include spinnerbait lures, which include a spinning element that attracts fish in darker environments. These types of lures include a rotating, oscillating or bobbing element that simulates a normal prey fish movement or movement of a prey when distressed to draw attention.

Surface treatments and rotating structures are of particular concern in low visibility water, where the goal is to have a predator fish notice and be attracted to the lure to make the fish engage and attempt to consume the lure as it moves through the water. Typical surface treatments include light reflective or polished surfaces that scatter light and draw attention to the lure. Accompanying the surface treatment is the motion of the lure, which is a considerably effective means of attracting a target fish. The motion of the lure creates disturbances in the water to appeal to the predator fish both visually and acoustically. Rotating structures of most lures include a single means of rotation to simulate a prey fish. The present invention is provided as a new lure structure that includes a new type of rotation for a lure and surface treatments to scatter light and attract fish while moving through the water.

The present invention includes a body structure having particular aerodynamic features to induce body roll as fluid moves over its surfaces, as well as providing an internal cavity within which a freely rotating member is positioned. The member includes surfaces that induce a counter rotation with respect to the body rotation, whereby the two structures rotate in opposite directions while traveling in a forward direction. The rotating surfaces scatter light within the water and present an attractive object to draw in fish, whereby a fish hook is used to snare the fish once the lure is ingested.

2. Description of the Prior Art

Devices have been disclosed in the prior art that relate to rotating fishing lure devices. These include devices that have been patented and published in patent application publications, and generally relate to lures having a singular body and a single rotation. None of the prior art devices include a counter rotating lure. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,516,553 to King discloses a fishing lure with a triangular shaped head and a mid body having folded fins that span outward. The fins extend angularly outward from the planar body and offset from one another, providing a means to spin the lure as fluid flows over its surface while deployed. A lure attachment line secures to a port along the triangular head portion, while the overall device may be attached to a swivel mechanism to allow rotation without spinning the fishing line. An embodiment further discloses a trailing end extending from the main body. While the King device discloses a spinning lure, its body structure and means of rotation differ from that of the present invention, which provides body rotation with an internally rotating element that spins independently of the body rotation.

U.S. Pat. No. 3,958,358 to Firmin discloses another spinning fishing lure having an elongated body member connected to a fishing line along its leading end, while its trailing end includes a pair of bifurcated wings or projections that disrupt the flow of air thereover when the lure is casted, rotating the fishing line to create a counter-rotation as the fishing line equalizes and causes the body of the lure to spin in the water. The body member may have several appendages extending therefrom to mimic a larger inset, while the rotation induced by the fishing line make the lure act like an injured insect thrashing in the water. The Firmin device is adapted to torque a fishing line while the lure is in the air, whereafter the return rotation of the line as it releases built up torque spins the lure in the water independent of fluid motion. The present invention is adapted to spin while the lure is reeled inward toward the fisherman, utilizing flowing water over the body of the device to spin its body section and its internal element.

U.S. Pat. No. 6,161,325 to Moore discloses a spinning, bi-parabolic fishing lure that includes a circumvoluted middle section that causes the lure to spin through the water when pulled by a fishing lure. The center of gravity of the lure is rearward of its longitudinal center, where its body section is preferably a shiny or light reflecting material to simulate a minnow. Together with its body motion, the lure appearance serves to attract fish as it is pulled through the water, while a rearward fish hook is adapted to snare the fish after it has ingested the lure into its mouth. While disclosing a spinning lure, the Moore device fails to disclose a spinning lure having an interiorly spinning attractor element as described by the present invention.

U.S. Pat. No. 6,108,964 to Noorlander discloses a device similar to Moore, in which a fishing lure is presented having a body section and a triangular rear section that form wings along the trailing edge of the body. The body is faceted with several edges, terminating at the rearward wings and a connection point for a rearward hook. The faceted edges and the outward directed wings allow the lure to spin when water flows over its surfaces, wherein the body experiences an oscillating pitching and yawing movements combined with side to side darting to mimic bait fish movement through the water. While the Noorlander device comprises a faceted body section having rearward wings similar to the present invention, an internal spinning element is provided in the present invention to increase the attraction to other fish as the lure is drawn through the water.

The present invention provides a fishing lure that includes a counter rotating structure to increase the moving surface and thus the reflection of light from its reflective surfaces as the body and interior element spin. The disbursement of light and sharp flashes created by the reflections attract fish and increase the visibility of the lure in darker waters. It is submitted that the present invention substantially diverges in design elements from the prior art, and consequently it is clear that there is a need in the art for an improvement to existing rotating fishing lure devices. In this regard the instant invention substantially fulfills these needs.

### SUMMARY OF THE INVENTION

In view of the foregoing disadvantages inherent in the known types of fishing lure devices now present in the prior art, the present invention provides a new counter rotating lure that can be utilized for increasing light dispersement as the lure moves through the water and its faceted surfaces move with the flow of fluid thereover.

It is therefore an object of the present invention to provide a new and improved fishing lure device that has all of the advantages of the prior art and none of the disadvantages.

It is another object of the present invention to provide a fishing lure device to provide a body structure adapted to induce body rotation as fluid flows over its surface, along with an independently spinning internal element adapted to spin in a counter direction with respect to the body.

Another object of the present invention is to provide a fishing lure device to provide an attractive lure having a multi-faceted body structure to reflect light from its surfaces as it moves and rotates through the water.

Yet another object of the present invention is to provide a fishing lure device that is adapted to connect to a barrel swivel along its leading end and to a fish hook along its trailing end.

A final object of the present invention is to provide a fishing lure in varying sizes and shapes that provide a counter rotating, reflective structure for different fishing applications and for different types of fish.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a side view of the present invention, highlighting its faceted shape.

FIG. 3 shows a perspective view of an embodiment of the present invention surface treatment and an embodiment of the internally rotating element.

### DETAILED DESCRIPTION OF THE INVENTION

Reference is made herein to the attached drawings. Like reference numerals are used throughout the drawings to depict like or similar elements of the fishing lure device. For the purposes of presenting a brief and clear description of the present invention, the preferred embodiment will be discussed as used for attracting fish using a counter rotating structure having reflective surfaces. The figures are intended for representative purposes only and should not be considered to be limiting in any respect.

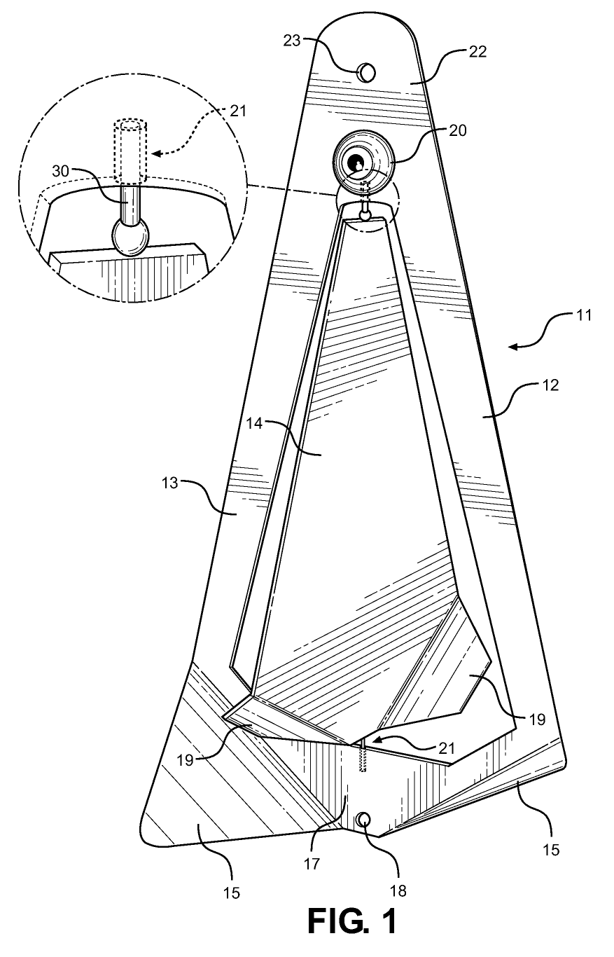

Referring now to FIG. 1, there is shown a perspective view of the fishing lure of the present invention. The device comprises a body section 11 having a leading end 22, a trailing end 17 and an open midsection bounded by a first and second peripheral member 12, 13 extending between the trailing 17 and leading end 22. The body section comprises a tapering section that forms a wedge or triangular shape, wherein the trailing edge corners are angled out of plane from the body section 11 to create a first and second fin 15. These fins have an upper surface and lower surface that when fluid flows thereover, create a pressure difference that induces a net force from the upper to the lower surface. The fins are oriented in differing directions with respect to the plane of the lure body section, whereby the two fins generate a net clockwise or counterclockwise axial rotation of the body 11 as fluid flows from the leading end 22 to the trailing end 17. This use of aerodynamic flow over the lure induces body roll as the lure travels through the water.

Within the open interior of the body section 11 is a freely rotating element 14 that is adapted to rotate in an opposite direction of that of the body 11. The internal member 14 includes a planar face and trailing fins 19, similar to that of the body fins 15; however the fins 19 of the internal member 14 are adapted to induce a rotation counter to the direction of the body member 11. The internal member 14 secures along its trailing and leading end via pin joint 21 that allows the member 14 to rotate along an elongated shaft 30 connected to a first and second socket in the body member. The overall lure is adapted to secure to a fishing line along its leading end 22 using a suitable connection, which may include an aperture 23 that secures to a barrel swivel that allow relative rotation with respect to the fishing line. Along the trailing end of the lure is provided an aperture 18 or similar connection means to connect to a fishing hook or further assemblies.

Along the body of the lure may be provided surface adornments or treatments that provide a reflective surface or one that resembles a prey fish while in the water. In this way, the lure is both eye catching to predator fish and resembles a fish likely to be consumed by that predator fish. Shown in FIG. 1 is a fish eye 20 placed along the leading end 22 of the lure. This is but one contemplated adornment, as different body shapes, appendages or other marker may be applied to improve the likeness of the lure to a living prey fish.

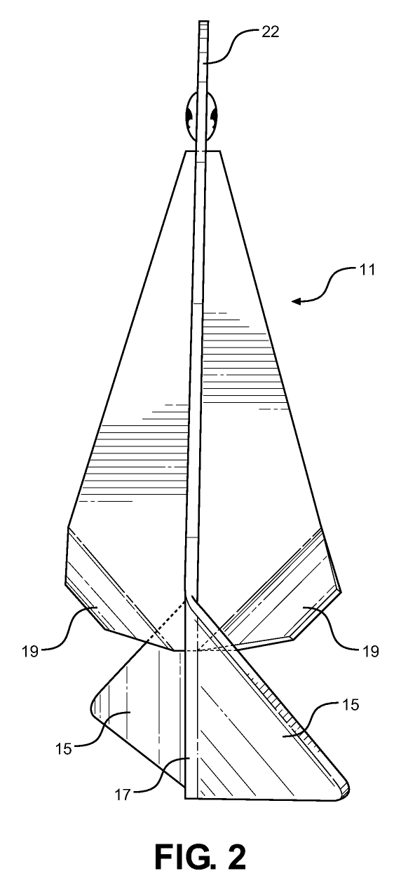

Referring now to FIG. 2, there is shown a side view of the present invention, highlighting its faceted body shape 11. The fins 19, 15 of the rotating element and the body trailing end create a counter rotating structure wherein the internal rotating element spins in reverse and freely from the spin of the body 11 of the lure. The shape of the lure is generally tapered; however the thickness may vary to resemble the shape of a fish and the exact structure may be altered to improve the attractiveness of the device while in the water. The leading end 22 of the lure is adapted to connect to a fishing tow line such that the lure can be pulled through the water towards the fisherman such that fluid flows over the lure surfaces to induce the rotation of both the body portion and the internal element.

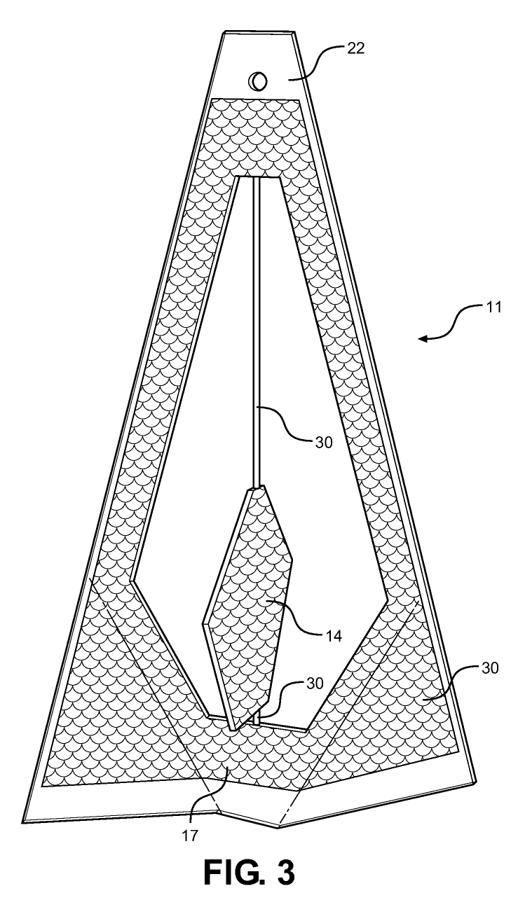

Referring now to FIG. 3, there is shown perspective view of an embodiment of the surface treatment 40 applied to the faceted surface of the lure body. The surface treatment 40 is ideally a reflective material that mimics the scales or skin of a prey fish. Also shown in this view is an embodiment of the internal element 14, wherein the element does not consume the entire cavity of the open body section 11 and its trailing end does not include outward fins. In this embodiment, the shape of the internal element induces rotation independently of the body section; however it does not have fins that control the direction of rotation of the element with respect to the body rotation.

Without a highly attractive and reflective fishing lure, fish may not be attracted to a fishing line, particularly in darker waters or in environment with more selective predator fish. With many different sensory attractions below the water, it may be difficult for fish to key in on any one particular line. Fishermen may become frustrated when fishing for hours with little to no action on their lines, wasting time, bait and energy. Similar fishing lures do not feature dual rotation, and thus cannot attract as many fish. The structure and design of the present invention mimics the movement and appearance of a fish in order to attract fish to a line. While a part of the lure rotates in a first direction, the body of the lure rotates in the opposite direction. This causes the lure reflective surfaces to display the maximum amount of reflective material at any given angle. Both the movement and reflective properties of the design increase the likelihood of attracting the attention of fish, which are then more likely to go after the device. Use of the present invention can help attract more quantities of fish to a line, increasing the success of the fisherman.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fishing lure device, comprising:
a body portion having a leading end, a trailing end and an open interior;
said body portion trailing end having a first and second fin projecting out of plane from said body portion to induce rotation of said body as fluid travels thereover;
a freely rotating internal element having a leading and trailing end within said body portion open interior supported by a first and second swivel joint at its leading and trailing end.

2) The device of claim 1, wherein said internal element trialing end further comprises a first and second fin projecting out of plane from said internal element to induce rotation opposite of said body rotation.

3) The device of claim 1, wherein said body portion and internal element further comprise a surface treatment that increases light reflectivity.

4) The device of claim 1, wherein said body leading end further comprises an aperture to connect to a barrel swivel.

6) The device of claim 1, wherein said body leading end further comprises an aperture to connect to a fishing line.

7) The device of claim 1, wherein said body trailing end further comprises an aperture to connect to a fishing hook.

8) The device of claim 1, wherein said body portion further comprises surface adornments to disguise said body portion as a prey fish.

9) The device of claim 1, wherein said body portion further comprises a generally tapering shape from said trailing end to said leading end.
